(19) United States
(12) Patent Application Publication
(10) Pub. No.: US 2012/0237278 A1
(43) Pub. Date: Sep. 20, 2012

(54) SHEET CONVEYING DEVICE THAT CAN CHANGE SHEET CONVEYING DIRECTION

(75) Inventors: Yuji Kobayashi, Toyohashi-shi (JP); Hiroshi Yamaguchi, Toyokawa-shi (JP); Yuta Tachibana, Toyokawa-shi (JP)

(73) Assignee: Konica Minolta Business Technologies, Inc., Chiyoda-ku (JP)

(21) Appl. No.: 13/422,072

(22) Filed: Mar. 16, 2012

(30) Foreign Application Priority Data
Mar. 18, 2011 (JP) 2011-060978

(51) Int. Cl. G03G 15/00

(52) U.S. Cl. 399/381

(57) ABSTRACT

A sheet conveying device includes: a roller that conveys a sheet; a leading end retaining member that temporarily retaining a front portion in a conveying direction of the sheet conveyed by the roller; a moving unit that moves a rear portion of the sheet toward a direction intersecting the conveying direction using a pushing member while the sheet is retained by the leading end retaining member, the pushing member being located on a downstream side of the roller; and an inverting and conveying roller that, after the moving unit moves the sheet, conveys the sheet while the rear portion of the sheet is set to a head.

### BACKGROUND OF THE INVENTION

1. Field of the Invention

The present invention relates to a sheet conveying device, particularly to a sheet conveying device that can change a sheet conveying direction.

2. Description of the Background Art

In an electrophotographic image forming apparatus (such as an MFP (Multi Function Peripheral) including a scanner function, a facsimile function, a copying function, a printer function, a data communication function, and a server function, a facsimile machine, a copying machine, and a printer), an image is formed in the sheet (irrespective of materials such as paper and film) by conveying the sheet that is of an image forming target. There is a sheet conveying device incorporated in the image forming apparatus or a sheet conveying device that is of an option of the image forming apparatus.

In the sheet conveying device, there is a double-sided sheet conveying device that inverts the sheet in order to form images in both sides of the sheet. In the double-sided sheet conveying device, the sheet is turned over by switchback (temporarily stops the sheet and conveys the sheet in the reverse direction) of the sheet conveyed in a predetermined feed direction from a fixing device.

The sheet inverting action is performed by inverting the sheet conveying direction using a normal roller pair. However, in this method, it is necessary to convey the subsequent sheet into an inverting route after the inverting action of the preceding sheet is completed. Therefore, the method becomes a bottleneck when a distance between the sheet is shortened to improve productivity. A motor start-up time and a motor ending time, which are necessary to feed the sheet to the inverting route and perform the inverting action in performing the switchback, also cause the productivity slowdown.

For example, in order to solve the problem, Document 1 listed below proposes a technology in which the sheet conveying direction is inverted by moving the sheet in the same route using air. More particularly, the conveyed sheet is sucked by a suction surface using the air, and a sucking and conveying device disposed to face the suction surface sucks the sheet at the same time as the air way is opened, thereby conveying the sheet. Therefore, a leading end and a tailing end of the sheet are inverted.

Document 2 listed below proposes a technology in which a suction belt that provides an electrostatic force to suck the sheet is twisted by 180 degrees. The sheet is conveyed while being sucked to the suction belt, thereby shortening a sheet inverting time.
Document 1: Japanese Patent Laying-Open No. 2010-64808
Document 2: Japanese Patent Laying-Open No. 2006-103855

However, in the technology of Document 1, it is necessary to move the preceding sheet using the air. Therefore, the next sheet cannot be conveyed into the inverting unit until the movement of the preceding sheet is completed. That is, it is necessary to move the sheet between the belts by utilizing the delivery and suction of the air, and therefore it is necessary to convey the sheet to the inverting unit after the movement of the preceding sheet is completed. There is a limitation to the shortening of the sheet conveying time. There is also a problem in that the stable conveyance of the sheet is hardly performed under various conditions such as a type of paper and a conveying speed.

In the technology of Document 2, the sheets are continuously inverted while being sucked to the belt twisted by 180 degrees, which results in a problem in that the sheet inverting route is lengthened.

### SUMMARY OF THE INVENTION

The invention is devised in order to solve the above problems, and an object of the invention is to provide a sheet conveying device that can efficiently convey the sheet.

In order to achieve the object, according to an aspect of the invention, a sheet conveying device includes: a first conveying unit for conveying a sheet; a retaining unit for temporarily retaining a front portion in a conveying direction of the sheet conveyed by the first conveying unit; a moving unit for moving a rear portion of the sheet toward a direction intersecting the conveying direction using a pushing member while the sheet is retained by the retaining unit, the pushing member being located on a downstream side of the first conveying unit; and a second conveying unit for, after the moving unit moves the sheet, conveying the sheet while the rear portion of the sheet is set to a head.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a sectional view illustrating an image forming apparatus in an embodiment of the invention.

FIG. 2 is a block diagram illustrating a hardware configuration of the image forming apparatus.

FIG. 3 is a block diagram illustrating a circuit configuration that drives a sheet conveying unit 20 and a sheet inverting unit 29.

FIG. 4 is a view schematically illustrating configurations of sheet conveying unit 20 and sheet inverting unit 29 in FIG. 1.

FIG. 5 is an enlarged view illustrating a configuration in the vicinity of a leading end retaining member 87 in FIG. 4.

FIG. 6 is a view illustrating a positional relationship among members in FIG. 5.

FIG. 7 is a view illustrating a positional relationship between a preceding sheet P1 and a subsequent sheet P2.

FIG. 8 is a flowchart illustrating a sheet conveying process, which is performed by a CPU 101 of an engine control board 30a, in sheet inverting unit 29.

FIG. 9 is a view schematically illustrating configurations of sheet conveying unit 20 and sheet inverting unit 29 in a first modification.

FIG. 10 is an enlarged view illustrating a configuration in the neighborhood of leading end retaining member 87 of the image forming apparatus in a second modification.

FIG. 11 is an enlarged view illustrating a configuration in the vicinity of leading end retaining member 87 of the image forming apparatus in a third modification.

FIG. 12 is an enlarged view illustrating a configuration in the vicinity of leading end retaining member 87 of the image forming apparatus in a fourth modification.

FIG. 13 is a flowchart illustrating the sheet conveying process, which is performed by CPU 101 of engine control board 30a, in sheet inverting unit 29 of the image forming apparatus in the fourth modification.

FIG. 14 is a flowchart illustrating the sheet conveying process, which is performed by CPU 101 of engine control board 30a, in sheet inverting unit 29 of the image forming apparatus when leading end retaining member 87 is fixed in an inverting point.

FIG. 15 is a flowchart illustrating the sheet conveying process, which is performed by CPU 101 of engine control board 30a, in sheet inverting unit 29 of the image forming apparatus when leading end retaining member 87 is moved in accordance with sheet movement in the configuration in FIG. 11.

### DESCRIPTION OF THE PREFERRED EMBODIMENTS

An image forming apparatus in an embodiment of the present invention will be described below.

The image forming apparatus can print an image on a sheet based on image data by an electrophotographic method. What is called a tandem type is adopted in the image forming apparatus, and the image forming apparatus is configured to be able to form a color image by combining four-color CMYK images.

### Embodiment

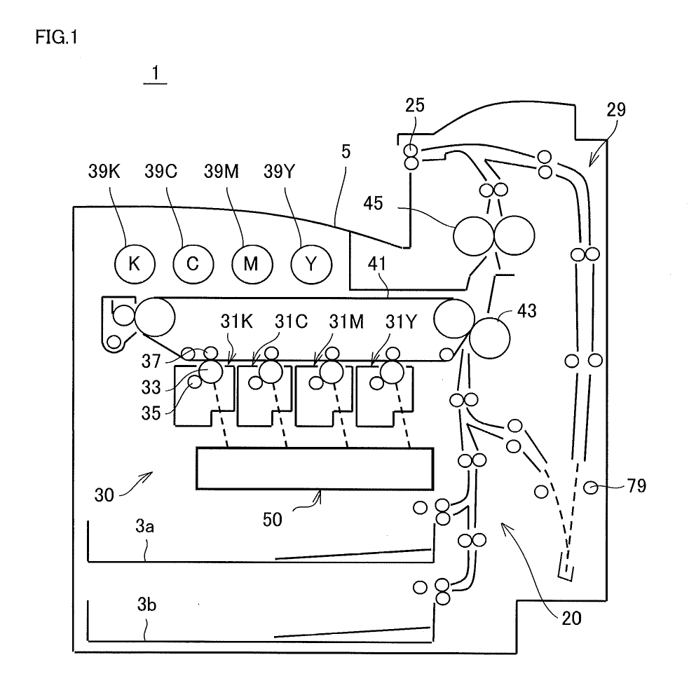

FIG. 1 is a sectional view illustrating the image forming apparatus in the embodiment of the present invention.

Referring to FIG. 1, an image forming apparatus 1 includes feed cassettes 3a and 3b and a discharge tray 5. A sheet conveying unit 20, a printer 30, and a controller (not illustrated) are provided in a chassis of an image forming apparatus 1. The controller is constructed by a CPU and a memory to control an action of image forming apparatus 1.

Image forming apparatus 1 includes two feed cassettes 3a and 3b. For example, sheets having different sizes (such as a B5 size, an A4 size, and an A3 size) are loaded on feed cassettes 3a and 3b. Feed cassettes 3a and 3b are disposed in a lower portion of image forming apparatus 1 while being able to be inserted in and drawn from the chassis of image forming apparatus 1. During print, the sheets loaded on feed cassettes 3a and 3b are fed one by one from feed cassettes 3a and 3b and delivered to printer 30. The number of feed cassettes is not limited to two, but at least one feed cassette may be provided in image forming apparatus 1.

Discharge tray 5 is disposed in an upper portion of image forming apparatus 1. The sheet on which the image is formed by printer 30 is discharged to discharge tray 5 from the inside of the chassis of image forming apparatus 1.

Sheet conveying unit 20 includes a feed roller, a conveying roller, a discharge roller (ejection roller) 25, and a motor (not illustrated) that drives the rollers. In the feed roller, the conveying roller, and the discharge roller, two rollers facing each other are rotated while nipping the sheet, thereby conveying the sheet. The feed roller feeds the sheet one by one from feed cassettes 3a and 3b or a manual feed unit (not illustrated) provided in image forming apparatus 1. The feed roller feeds the sheet into the chassis of image forming apparatus 1. The conveying roller conveys the sheet fed by the feed roller to printer 30. The conveying roller also conveys the sheet passing through a fixing roller (fixing device) 45 to discharge roller 25. Discharge roller 25 discharges the sheet conveyed by the conveying roller to the outside of the chassis of image forming apparatus 1. The discharged sheet is stacked on discharge tray 5.

Sheet inverting unit 29 is provided in sheet conveying unit 20. Use of sheet inverting unit 29 can perform double-sided print to the sheet. In this case, on a downstream side of fixing roller 45, a sheet is fed to sheet inverting unit 29, and a conveying direction of the sheet passed through fixing roller 45 is switched by the action of sheet inverting unit 29. Then, in a sheet conveying route, the sheet is conveyed in a region on an upstream side of printer 30. Therefore, the sheet is conveyed to printer 30 while turned over. Accordingly, the images can be formed in both sides of the sheet.

Printer 30 includes four printheads 31K, 31C, 31M, and 31Y (hereinafter simply referred to as a printhead 31), four-color toner cartridges 39K, 39C, 39M, and 39Y, an intermediate transfer belt 41, a secondary transfer roller 43, a fixing device 45, and a light beam scanning device 50.

Circular intermediate transfer belt 41 is entrained about plural rollers. Intermediate transfer belt 41 is rotated in conjunction with sheet conveying unit 20. Secondary transfer roller 43 is disposed so as to face a portion that is in contact with one of the rollers in intermediate transfer belt 41. The sheet is conveyed while nipped between intermediate transfer belt 41 and secondary transfer roller 43.

Each printhead 31 includes a photosensitive drum (an example of the image bearing member) 33, a development device 35, a cleaner, and a charger. Printheads 31K, 31C, 31M, and 31Y are provided to form the CMYK color images of black (K), cyan (C), magenta (M), and yellow (Y), respectively. Printheads 31K, 31C, 31M, and 31Y are arrayed immediately below intermediate transfer belt 41 in the order from the upstream side of the rotation of intermediate transfer belt 41. A primary transfer roller 37 is disposed above each photosensitive drum 33 such that intermediate transfer belt 41 is nipped between primary transfer roller 37 and photosensitive drum 33.

Fixing device (fixing roller) 45 includes a heating roller and a pressurizing roller. In fixing device 45, the sheet in which the toner image is formed is conveyed while nipped between the heating roller and the pressurizing roller, thereby heating and pressurizing the sheet. Therefore, fixing device 45 melts toner adhering to the sheet, and fixes the toner to the sheet to form the image in the sheet. The sheet passing through fixing device 45 is discharged from the chassis of image forming apparatus 1 by discharge roller 25.

Light beam scanning device 50 is disposed below printhead 31. Light beam scanning device 50 is integrally unitized. Light beam scanning device 50 scans photosensitive drum 33 of each printhead 31 with a laser beam. In light beam scanning device 50, lower surface side is supported by a frame (an example of the support member) of image forming apparatus 1.

Light beam scanning device 50 forms a latent image on each of photosensitive drums 33, which is charged evenly by the charger, based on the image data of each of the CMYK colors. Development device 35 forms a toner image on each of photosensitive drums 33 in each color. Primary transfer roller 37 transfers the toner image on each photosensitive drum 33 to intermediate transfer belt 41, and forms a mirror image of the toner image formed in the sheet on intermediate transfer belt 41 (primary transfer). The toner images are formed on intermediate transfer belt 41 in the order of black, cyan, magenta, and yellow. Then secondary transfer roller 43 transfers the toner image formed on intermediate transfer belt 41 to the sheet, thereby forming the toner image on the sheet (secondary transfer).

A conveying route of sheet inverting unit 29 includes an inverting mechanism that switches the sheet conveying direction. A point at which a leading end of the sheet before an inverting action is switched to a tailing end of the sheet by the inverting action is referred to as an “inverting point”. In FIG. 1, the inverting point is provided in a lower right portion of image forming apparatus 1.

The preceding sheet and the subsequent sheet are continuously conveyed by the conveying roller at predetermined intervals. The sheet is conveyed to the inverting point by the conveying roller. A pushing member 79 that is located in a first position (initial position) on the downstream side of the conveying roller moves after the tailing end of the preceding sheet passes through the last conveying roller located upstream of the inverting point. Pushing member 79 turns the sheet with the leading end of the preceding sheet as a pivot point, and pushes the sheet onto the inverting route side.

In inverting route, the sheet is conveyed as the tailing end of the sheet being the front. After the preceding sheet is inserted in an inverting roller (inverting and conveying roller) located on the downstream side of the inverting route, the pushing member is returned to the first position (initial position) at a time the leading end of the subsequent sheet, which is currently conveyed by the last conveying roller located upstream of the inverting point, does not collide with the pushing member.

In the embodiment, the pushing member is the roller. Alternatively, a rod-shaped member or a plate-like member may be used as the pushing member. In the inverting route, a roller is provided in a position facing the roller that is of the pushing member. When the roller that is of the pushing member abuts on the roller located in the position facing the pushing member, the rollers are driven by a driving source to invert and convey the sheet.

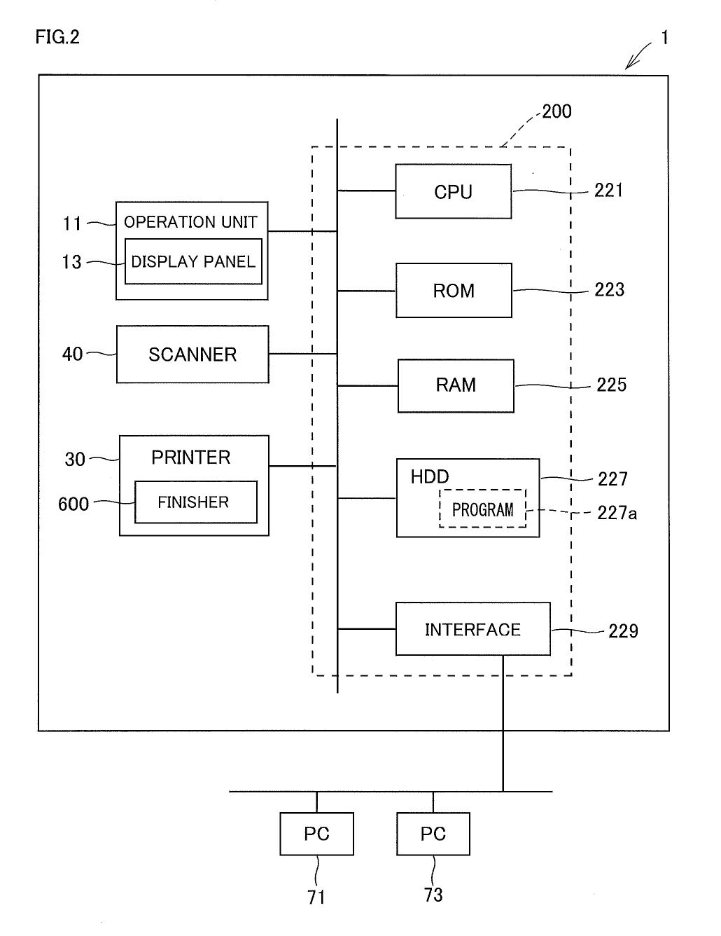

FIG. 2 is a block diagram illustrating a hardware configuration of image forming apparatus 1.

Referring to FIG. 2, a controller 200 includes a CPU 221, a ROM 223, a RAM 225, a HDD 227, and an interface 229. Controller 200, an operation unit 11, printer 30, and a scanner 40 are connected to a system bus. Therefore, controller 200 and each unit of image forming apparatus 1 are connected so as to be able to transmit and receive a signal.

Job data transmitted from the outside through interface 229 and image data read with scanner 40 are stored in HDD 227. Setting information on image forming apparatus 1 and a control program (program) 227a for various actions of image forming apparatus 1 are also stored in HDD 227. Plural jobs transmitted from one or plural client PCs 71, 73 can be stored in HDD 227.

For example, interface 229 is constructed by a combination of a hardware unit such as an NIC (Network Interface Card) and a software unit that conducts communication based on a predetermined communication protocol. Interface 229 connects image forming apparatus 1 to an external network such as a LAN. Therefore, image forming apparatus 1 can conduct communication with an external device, such as the client PC, which is connected to the external network. In FIG. 2, image forming apparatus 1 is connected to the external network to which a PC 71 and a PC 73 are connected. Image forming apparatus 1 can receive the job from PCs 71 and 73. Image forming apparatus 1 can transmit the image data read with scanner 40 to PC 71 or transmit e-mail of the image data through a mail server. Interface 229 may be configured to be able to be connected to the external network through wireless communication. For example, interface 229 may be a USB (Universal Serial Bus) interface. In this case, interface 229 enables image forming apparatus 1 to conduct communication with the external device connected through a communication cable.

CPU 221 controls various actions of image forming apparatus 1 by executing control program 227a and the like stored in ROM 223, RAM 225, or HDD 227. When an operation signal is transmitted from operation unit 11, or when an operation command is transmitted from PC 71, CPU 221 executes control program 227a in response to the operation signal or the operation command. Therefore, a predetermined action of image forming apparatus 1 is performed according to the user's operation of operation unit 11.

For example, ROM 223 is a flash ROM (Flash Memory). The data used in the action of image forming apparatus 1 is stored in ROM 223. Similarly to HDD 227, various control programs and various pieces of function setting data of image forming apparatus 1 may be stored in ROM 223. CPU 221 performs predetermined processing to read and write the data from and in ROM 223. ROM 223 may be a memory in which the data cannot be rewritten.

RAM 225 is a main memory of CPU 221. RAM 225 is used to store the necessary data when CPU 221 executes control program 227a.

Scanner 40 performs the scanner function to read the image data from a manuscript. The image data read with scanner 40 is converted into an application data format by CPU 221 and stored in HDD 227. CPU 221 can transmit the image data stored in HDD 227 to PCs 71 and 73.

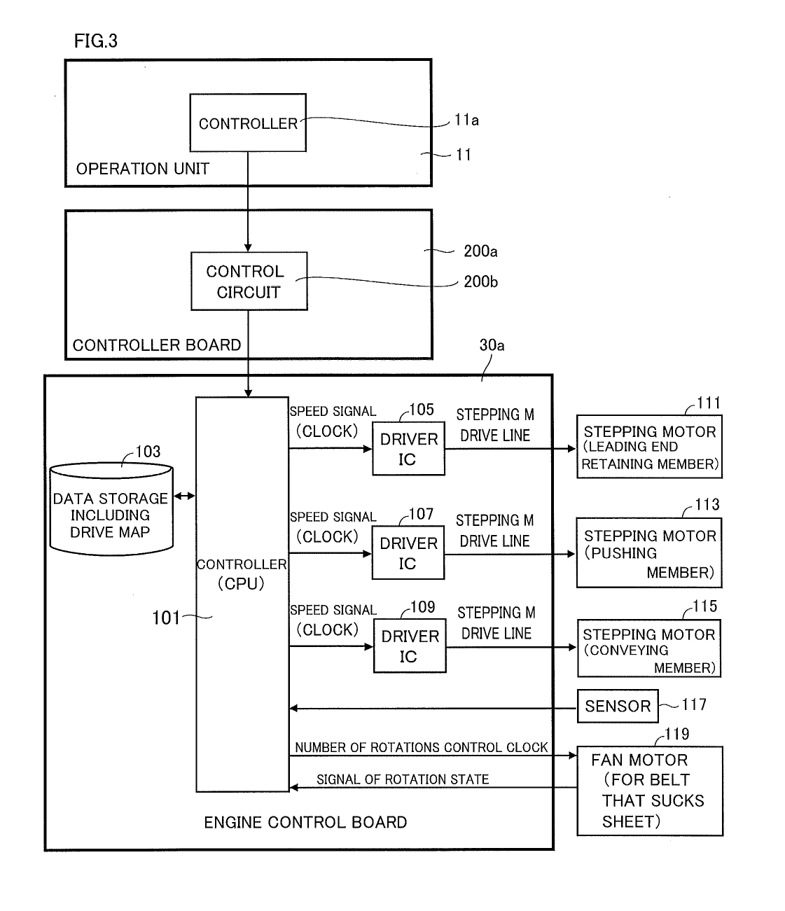

FIG. 3 is a block diagram illustrating a circuit configuration that drives sheet conveying unit 20 and sheet inverting unit 29.

Operation unit (operation panel) 11 includes a controller 11a that processes information based on the user's operation. A controller board 200a is provided in a controller 200, and a control circuit 200b of controller board 200a processes various pieces of information.

Engine control board 30a is provided in printer 30. Engine control board 30a includes a data storage 103 that is constructed by a RAM, a controller (CPU) 101, and driver ICs 105, 107, and 109 that drive stepping motors based on a speed signal (clock) from controller 101.

Operation information (data) generated in operation unit 11 is transmitted to control circuit 200b by controller 11a. CPU 101 controls each load based on the operation information. More particularly, CPU 101 drives each stepping motor in predetermined timing at predetermined speed according to a setting mode of the user. CPU 101 activates a motor in response to a signal from various sensors 117.

Engine control board 30a is connected to a stepping motor 111 that drives the leading end retaining member, a stepping motor 113 that drives the pushing member, a stepping motor 115 that drives the conveying member including the plural conveying rollers (such as the double-sided conveying roller and the inverting and conveying roller), a sensor 117 including a sensor SE, and a fan motor 119.

Fan motor 119 drives a fan provided in the inverting and conveying belt when the inverting and conveying belt is used, and CPU 101 activates fail motor 119.

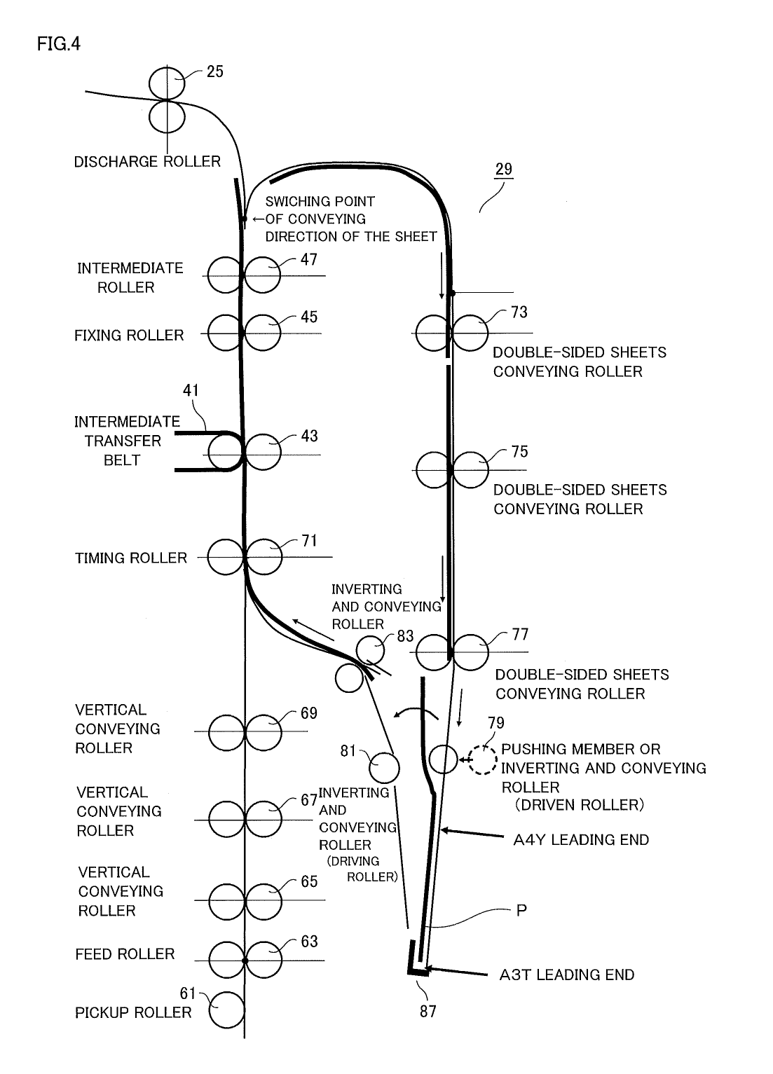

FIG. 4 is a view schematically illustrating configurations of sheet conveying unit 20 and sheet inverting unit 29 in FIG. 1.

Referring to FIG. 4, the sheet is taken out one by one by a pickup roller 61 provided in the lower portion of image forming apparatus 1, and conveyed in image forming apparatus 1. For the single-sided print, a feed roller 63, a vertical conveying roller 65, a vertical conveying roller 67, a vertical conveying roller 69, a timing roller 71, a secondary transfer roller 43, fixing roller 45, an intermediate roller 47, and discharge roller 25 convey the sheet in the order from the upstream side.

For the double-sided print, the sheet to which the single-sided print is performed is fed toward leading end retaining member 87 through a double-sided conveying roller 73, a double-sided conveying roller 75, and a double-sided conveying roller 77 by an action of a sheet route switching point provided on the downstream side of intermediate roller 47.

A tailing end portion of a sheet P, when a leading end of sheet P is retained by leading end retaining member 87, is moved to the left side by the movement of pushing member 79. When the movement of the tailing end portion of sheet P is completed, switchback conveyance of the sheet is performed through an inverting and conveying roller 81 and an inverting and conveying roller 83, and the sheet is fed to timing roller 71. The sheet is conveyed by secondary transfer roller 43, fixing roller 45, intermediate roller 47, and discharge roller 25, thereby completing the print of the rear surface.

The initial position of pushing member 79 is indicated by a dotted-line circle. After the tailing end of sheet P passes through the nip portion of double-sided conveying roller 77, the leading end of sheet P is retained by leading end retaining member 87. Then pushing member 79 moves in a direction indicated by a solid-line circle, whereby sheet P turns on the leading end of sheet P.

Pushing member 79 is constructed by a driven roller, and also acts as the inverting and conveying roller. Inverting and conveying roller 81 is a driving roller that is driven by stepping motor 115. When pushing member 79 comes into contact with inverting and conveying roller 81 with sheet P interposed therebetween, sheet P moves upward by a driving force of inverting and conveying roller 81 until sheet P is inserted in inverting and conveying roller 83.

The inverting route is constructed by inverting and conveying roller 81 and inverting and conveying roller 83 in FIG. 4.

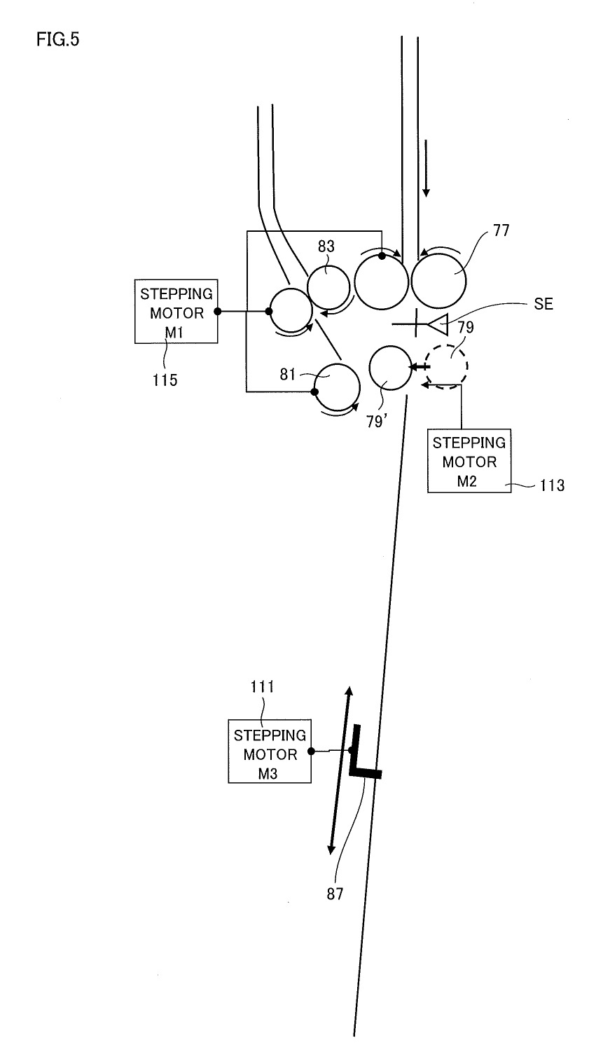

FIG. 5 is an enlarged view illustrating a configuration in the vicinity of leading end retaining member 87 in FIG. 4.

As illustrated in FIG. 5, double-sided conveying roller 77, inverting and conveying roller 81, and inverting and conveying roller 83 are driven by stepping motor 115. Pushing member 79 is moved in a horizontal direction in FIG. 5 (the direction intersecting the sheet conveying direction or the direction orthogonal to the sheet conveying direction) by stepping motor 113. In FIG. 5, the initial position (rightmost position) of pushing member 79 is indicated by the dotted-line circle, and a position in which pushing member 79 moves currently leftward is indicated by a solid-line circle 79′. Pushing member 79 reciprocates according to normal-rotation and reverse-rotation actions of stepping motor 113. The sheet is fed downward in FIG. 5 in the case pushing member 79 is located in the right position, and the sheet is fed upward in the case pushing member 79 is located in the left position.

Leading end retaining member 87 is vertically driven by stepping motor 111. Leading end retaining member 87 reciprocates according to normal-rotation and reverse-rotation actions of stepping motor 111. The position of leading end retaining member 87 is controlled according to a size (length) of the sheet in the conveying direction. Specifically, stepping motor 111 is driven such that leading end retaining member 87 is located in the position in which tailing end (upper end portion in FIG. 5) of the sheet is separated from a nip portion of double-sided conveying roller 77 when the leading end (lower end portion in FIG. 5) of the conveyed sheet abuts on leading end retaining member 87, and such that leading end retaining member 87 is located in the position in which the sheet is nipped in the nip portion between inverting and conveying roller 81 and pushing member 79 when pushing member 79 moves from the right to the left.

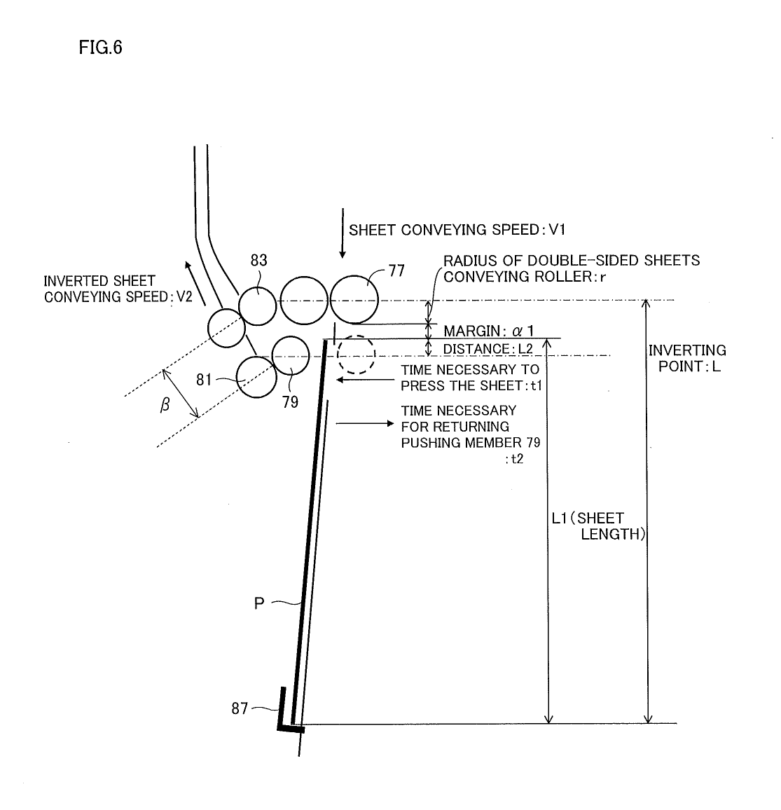

FIG. 6 is a view illustrating a positional relationship among members in FIG. 5.

In FIG. 6, pushing member 79 is located leftmost as indicated by the solid-line circle, and pushing member 79 and inverting and conveying roller 81 constitute the nip portion.

Sheet P is located in a position (lowermost position) in which the leading end of sheet P is retained by leading end retaining member 87. It is assumed that V1 is a sheet conveying speed at which the sheet is moved downward in FIG. 6 by double-sided conveying roller 77 and V2 is an inverted sheet conveying speed at which the sheet is conveyed in the inverting route. It is assumed that L1 is a length (sheet length) of the sheet in the conveying direction.

It is assumed that r is a radius of double-sided conveying roller 77 and L is a distance (a distance to the inverting point) from the center (a nip position of the sheet) of double-sided conveying roller 77 to leading end retaining member 87. It is assumed that a margin α1 is a distance from the lower end portion of double-sided conveying roller 77 to the tailing end of sheet P in FIG. 6. It is assumed that β is a distance from the nip portion between inverting and conveying roller 81 and pushing member 79 to the nip portion of inverting and conveying roller 83.

It is assumed that t1 is a time (a time necessary to press the sheet) that is necessary for pushing member 79 moving in the left direction to press the sheet and t2 is a time necessary for pushing member 79 to return to the initial position. It is assumed that L3 is an interval between sheet P and the sheet subsequent to sheet P. It is assumed that L2 is a distance in the conveying direction from the tailing end of sheet P in FIG. 6 to the central portion of pushing member 79.

In the embodiment, the following relationships hold.

L>L1+r (1)

L2>(t1+t2)×V1 (2)

and V2≧V1×(L1+β−L3)/L1 (3)

When the margin is added to the equations (1) and (2), the equations (1) and (2) are expressed by

L=L1+r+α1 (1′)

and L2=(t1+t2+α2)×V1 (2′)

(where α2 is a temporal margin).

A numerical value L indicating the position of the inverting point in the equation (1) is used to fix a trouble-free positional relationship among the members when pushing member 79 pushes sheet Pin the left direction after the sheet is retained by leading end retaining member 87.

Numerical value L2 indicating the position of pushing member 79 in the equation (2) is used to fix the position of pushing member 79 such that the trouble is not generated in conveying the subsequent sheet.

Numerical value V2 in the equation (3) is used to fix the speed of the inverted sheet such that the subsequent sheet does not come into contact with the preceding sheet.

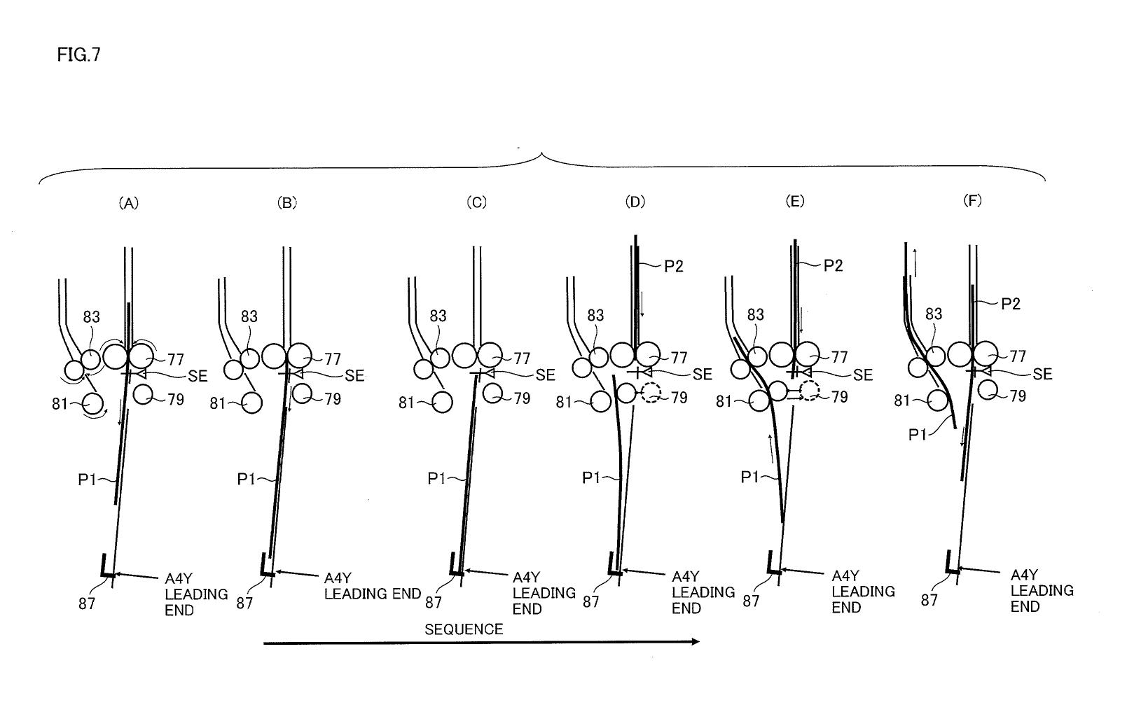

FIG. 7 is a view illustrating a positional relationship between a preceding sheet P1 and a subsequent sheet P2.

In FIG. 7, sheet conveying situations are illustrated in time series in the order of FIG. 7(A) to FIG. 7(F). It is assumed that A4Y (transverse feed of an A4-size sheet, namely, the A4-size sheet that is conveyed while a short side of the sheet is parallel to the conveying direction) is a manuscript size of conveyed sheet P.

FIG. 7(A) illustrates the state in which sheet P1 is conveyed downward by the rotation of double-sided conveying roller 77. In the state in FIG. 7(A), sensor SE located immediately below double-sided conveying roller 77 detects the passage of sheet P1 and becomes an on-state. Pushing member 79 is waiting in the initial position (right end) so as not to block the passage of sheet P1. At this point, inverting and conveying rollers 81 and 83 may be rotated, or inverting and conveying rollers 81 and 83 may start the rotation when sheet P1 is fed to the inverting route or immediately before sheet P1 is fed to the inverting route.

Then, as illustrated in FIGS. 7(B) and 7(C), sheet P1 moves downward to the position in which the leading end of sheet P is supported by leading end retaining member 87 (inverting point). When the tailing end of sheet P1 passes by the position of sensor SE, as illustrated in FIG. 7(D), pushing member 79 moves leftward to turn sheet P1 counterclockwise about the leading end of sheet P1. Pushing member 79 moves to the position in which the sheet is nipped between pushing member 79 and inverting and conveying roller 81. Because pushing member 79 is constructed by the driven roller to have the function of the inverting and conveying roller, as illustrated in FIG. 7(E), the inverting and conveying action is performed to set the tailing end side of the sheet to the travelling direction when the sheet is nipped. At this point, when sheet P1 is inserted in the nip portion of inverting and conveying roller 83, pushing member 79 starts a retreat action (rightward movement), and then returns to the initial position.

As illustrated in FIG. 7(D), after the leftward movement of pushing member 79 is started, subsequent sheet P2 is inserted in the nip portion of double-sided conveying roller 77 and conveyed toward the inverting point. Before pushing member 79 retreats to the initial position, sheet P2 is fed by double-sided conveying roller 77. As illustrated in FIGS. 7(E) and 7(F), sheet P2 is conveyed toward the inverting point at the time sheet P2 does not collide with retreating pushing member 79.

As illustrated in FIGS. 7(E) and 7(F), before sheet P1 passes through inverting and conveying roller 81, sheet P2 is conveyed at the time the head of sheet P2 passes by pushing member 79 that retreats in the initial position. Sheets P1 and P2 move while passing each other (move in different directions while facing each other). Therefore, a sheet conveying space is reduced, and the efficiency and speed of the sheet conveyance can be enhanced.

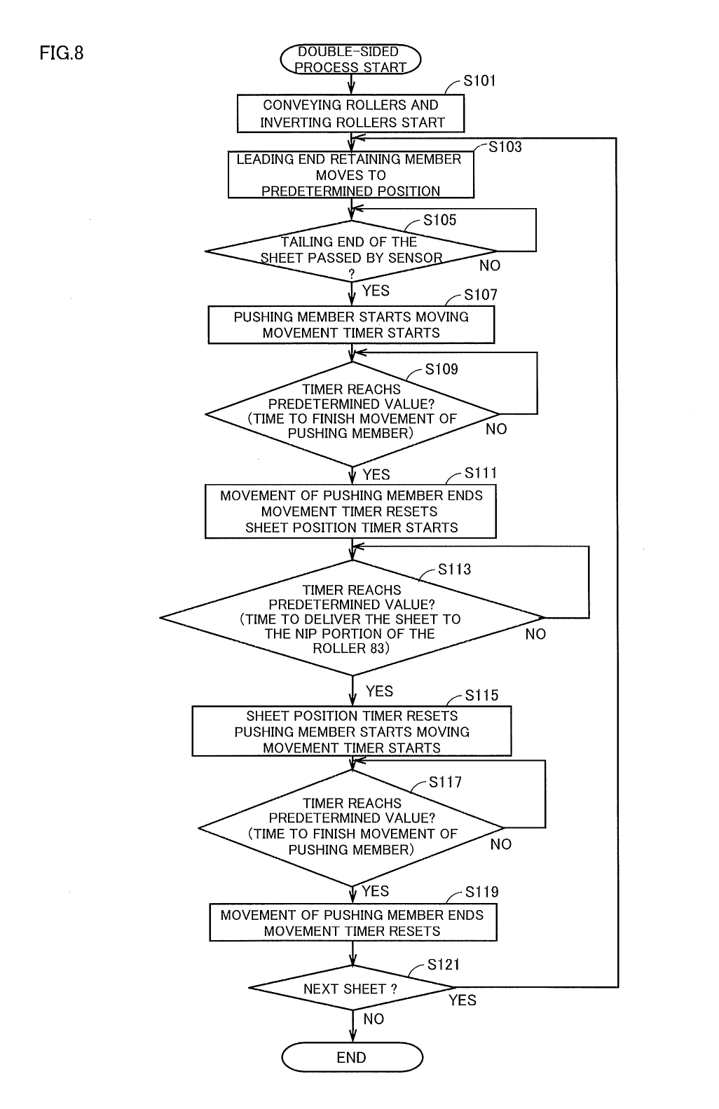

FIG. 8 is a flowchart illustrating a sheet conveying process, which is performed by CPU 101 of engine control board 30a, in sheet inverting unit 29.

Referring to FIG. 8, in Step S101, drive of a conveying roller group (a conveyance-related roller group including double-sided conveying roller 77 and inverting and conveying rollers 81 and 82) is started by driving stepping motor 115. In Step S101, leading end retaining member 87 is disposed in a predetermined position by driving stepping motor 111. In the disposition, CPU 101 processes pieces of information on the sheet size and a sheet orientation, which are transmitted from control circuit 200b, whereby the most suitable position of leading end retaining member 87 is fixed in order to invert the conveyed sheet. Stepping motor 111 is controlled such that leading end retaining member 87 is located in the most suitable position.

In Step S105, CPU 101 determines whether the tailing end of the sheet passes by sensor SE, and CPU 101 waits for the passage of the sheet. When the tailing end of the sheet passes by sensor SE, the movement of pushing member 79 from the initial position is started by driving stepping motor 113 in Step S107. Counting of a movement timer is started.

In Step S109, CPU 101 determines whether the movement timer reaches a predetermined value. As used herein, the predetermined value means a value (a time necessary to move pushing member 79) necessary to nip the sheet between pushing member 79 and inverting and conveying roller 81.

When the affirmative determination is made in Step S109, the movement of pushing member 79 is ended in Step S111. The movement timer is reset to start counting of a sheet position timer.

In Step S113, CPU 101 determines whether the sheet position timer reaches a predetermined value. As used herein, the predetermined value means a value (a time for which pushing member 79 should wait) necessary for pushing member 79 and inverting and conveying roller 81 to deliver the end portion of the sheet to the nip portion of inverting and conveying roller 83.

The affirmative, determination is made in Step S113, the sheet position timer is reset to start the counting of the movement timer in Step S115. The movement of pushing member 79 toward the initial position is started by driving stepping motor 113.

In Step S117, CPU 101 determines whether the movement timer reaches a predetermined value. As used herein, the predetermined value means a value (a time necessary to move pushing member 79) necessary to return pushing member 79 to the initial position.

When the affirmative determination is made in Step S117, the movement of pushing member 79 is ended in Step S119. The movement timer is reset.

In Step S121, CPU 101 determines whether the next sheet exists. When the next sheet exists, CPU 101 performs the sheet conveying process from the processing in Step S103. When the next sheet does not exist, CPU 101 ends the sheet conveying process in FIG. 8.

### [First Modification]

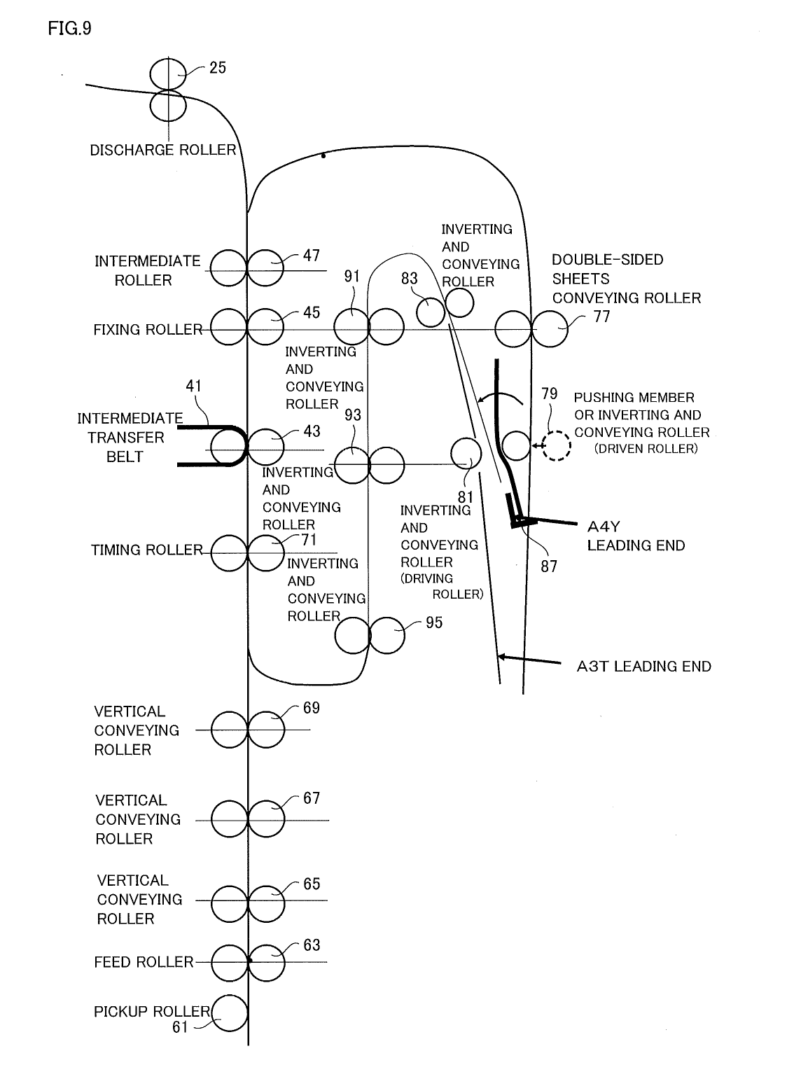

FIG. 9 is a view schematically illustrating configurations of sheet conveying unit 20 and sheet inverting unit 29 in a first modification.

The first modification differs from the configuration in FIG. 4 in that double-sided conveying rollers 73 and 75 are not provided in sheet inverting unit. The sheet conveyed by intermediate roller 47 is directly conveyed to double-sided conveying roller 77.

On the other hand, inverting and conveying rollers 91, 93, and 95 are interposed between inverting and conveying roller 83 and timing roller 71.

Therefore, advantageously the length of sheet inverting unit 29 can be shortened in the vertical direction to form the compact image forming apparatus.

### [Second Modification]

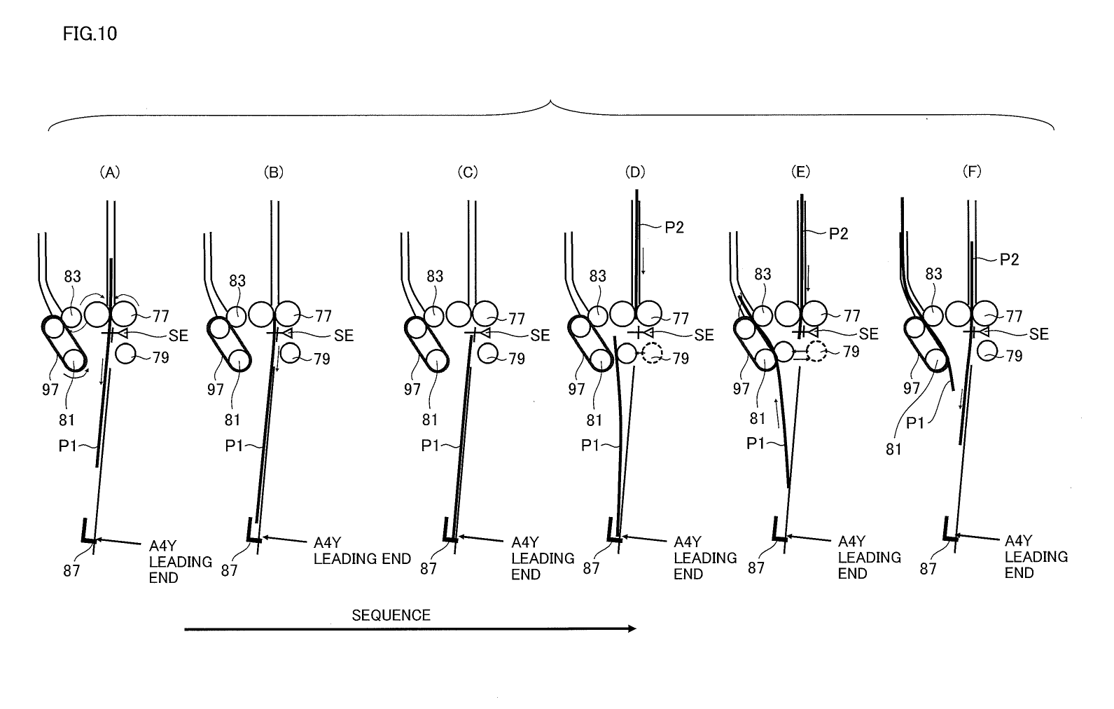

FIG. 10 is an enlarged view illustrating a configuration in the vicinity of leading end retaining member 87 of the image forming apparatus in a second modification.

In FIG. 10, similarly to FIG. 7, the positional relationship between the preceding sheet P1 and the subsequent sheet P2 is illustrated, and the sheet conveying situations are illustrated in time series in the order of FIG. 10(A) to FIG. 10(F).

The image forming apparatus of the second modification differs from the image forming apparatus of the embodiment in that inverting and conveying belt 97 is entrained between inverting and conveying rollers 81 and 83. In the second modification, pushing member 79 moves to the position in which pushing member 79 abuts on inverting and conveying belt 97 with the sheet interposed therebetween.

In the second modification, the sheet can be gripped between pushing member 79 and inverting and conveying belt 97, and the sheet can be conveyed using inverting and conveying belt 97 as illustrated in FIGS. 10(E) and 10(F). Therefore, advantageously the sheet is stably conveyed.

The sheet can be conveyed only by inverting and conveying belt 97, and it is not necessary to nip the sheet between inverting and conveying belt 97 and pushing member 79. In this case, the retreat of pushing member 79 to the initial position may be started immediately after the inverting and conveying belt 97 starts the conveyance of the sheet (or immediately after pushing member 79 moves the sheet onto the side of inverting and conveying belt 97).

### [Third Modification]

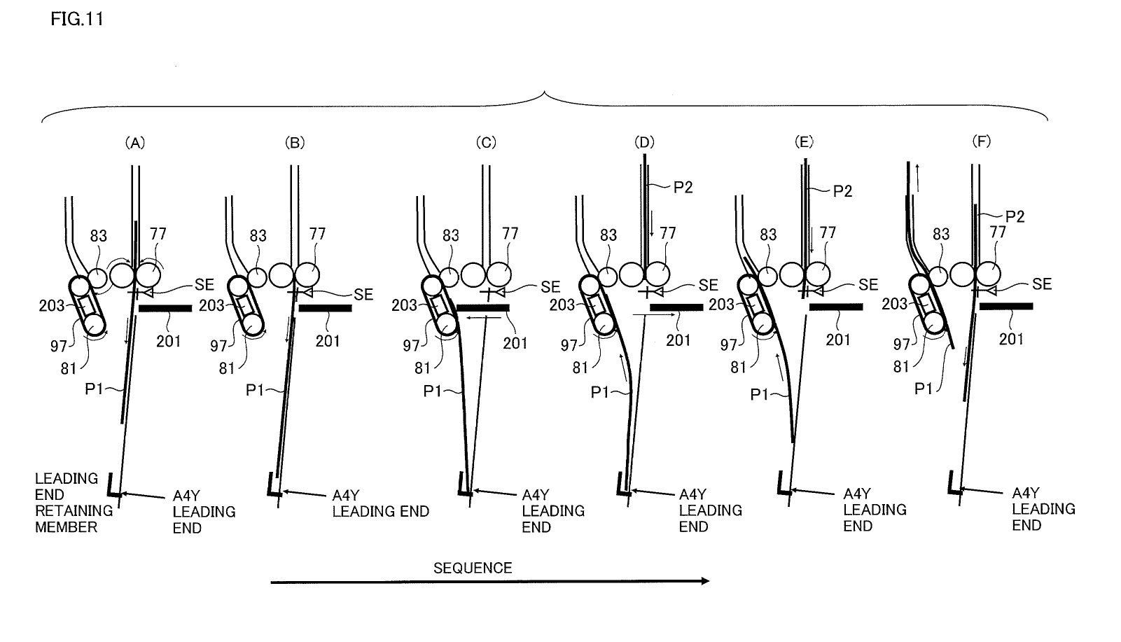

FIG. 11 is an enlarged view illustrating a configuration in the vicinity of leading end retaining member 87 of the image forming apparatus in a third modification.

In FIG. 11, similarly to FIG. 10, the positional relationship between preceding sheet P1 and subsequent sheet P2 is illustrated, and the sheet conveying situations are illustrated in time series in the order of FIG. 11(A) to FIG. 11(F).

The image forming apparatus of the third modification differs from the image forming apparatus in FIG. 10 in that many holes are made in inverting and conveying belt 97 and that air can pass through the holes in inverting and conveying belt 97. A fan 203 that sucks the air is provided in circular inverting and conveying belt 97. Fan 203 is rotated by fan motor 119, and CPU 101 controls the rotation of fan 203.

In the third modification, a rod-shaped member or a plate-like member that covers the length in the direction orthogonal to the sheet conveying direction is used as a pushing member 201. The pushing member may be the driven roller in FIGS. 4 to 7.

In the third modification, when the tailing end of the sheet passes by the position of sensor SE, pushing member 201 moves to the left to push the tailing end of the sheet onto the side of inverting and conveying belt 97. The sheet is attracted and sucked to inverting and conveying belt 97 by the suction force of fan 203. At this point, the sheet is delivered to inverting and conveying roller 83, and conveyed on the downstream side of inverting and conveying roller 83.

### [Fourth Modification]

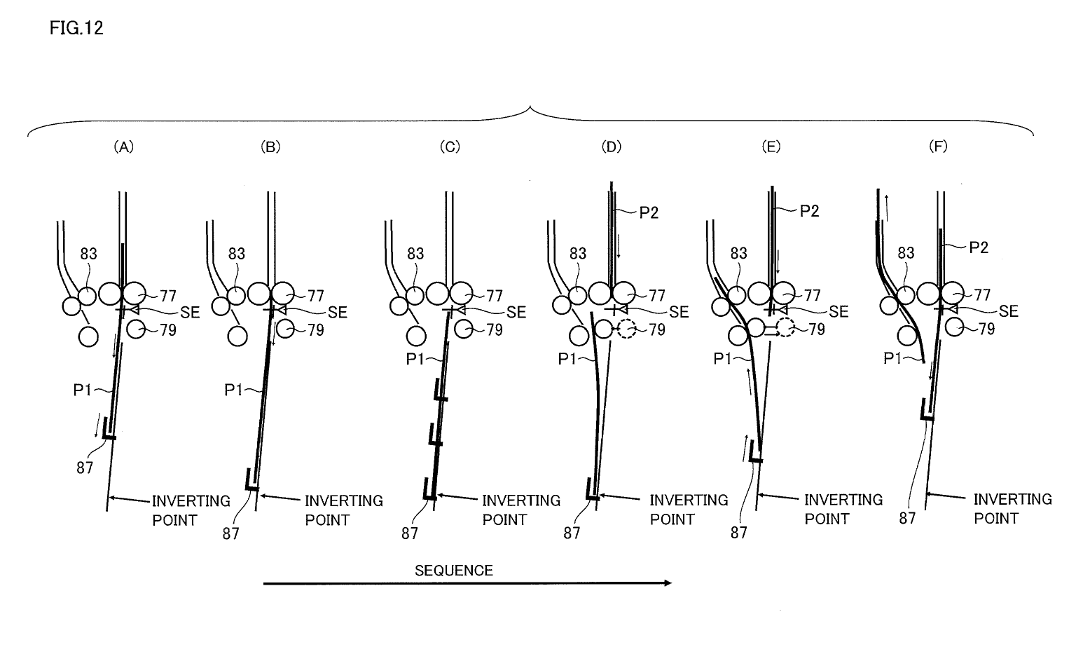

FIG. 12 is an enlarged view illustrating a configuration in the vicinity of leading end retaining member 87 of the image forming apparatus in a fourth modification.

In FIG. 12, similarly to FIG. 7, the positional relationship between preceding sheet P1 and subsequent sheet P2 is illustrated, and the sheet conveying situations are illustrated in time series in the order of FIG. 12(A) to FIG. 12(F).

The image forming apparatus of the fourth modification differs from the image forming apparatus in FIG. 7 in that leading end retaining member 87 is moved in conjunction with the sheet conveyance while the leading end portion of the sheet is retained by leading end retaining member 87 (or while the distance between leading end retaining member 87 and the leading end portion of the sheet is maintained at 1 cm to several millimeters) and that the sheet inverting action is performed.

Specifically, the initial position of leading end retaining member 87 is set to the position between the sheet inverting point and double-sided conveying roller 77 (or the position closest to the side of double-sided conveying roller 77 may be set to the initial position).

Leading end retaining member 87 reciprocates between the initial position and the inverting point. The initial position and the inverting point are fixed such that CPU 101 receives the pieces of information on the size and the direction of the sheet from control circuit 200b.

As illustrated in FIG. 12(A), after sensor SE detects the passage of the leading end of sheet P1; CPU 101 measures passage of a predetermined time to determine that the leading end portion of sheet P1 reaches the initial position of leading end retaining member 87. As illustrated in FIG. 12(B), leading end retaining member 87 moves along with the leading end portion of sheet P1 to the inverting point. As illustrated in FIG. 12(C), the inverting point is changed depending on the size and direction of the sheet.

After the tailing end of sheet P1 passes through sensor SE, pushing member 79 moves to the left as illustrated in FIG. 12(D). After inverting and conveying roller 83 can convey sheet P1, pushing member 79 returns to the initial position as illustrated in FIG. 12(E). Leading end retaining member 87 moves to the initial position in association with the movement of the end portion of the sheet. At this point, the inverting action of next sheet P2 is started as illustrated in FIG. 12(F).

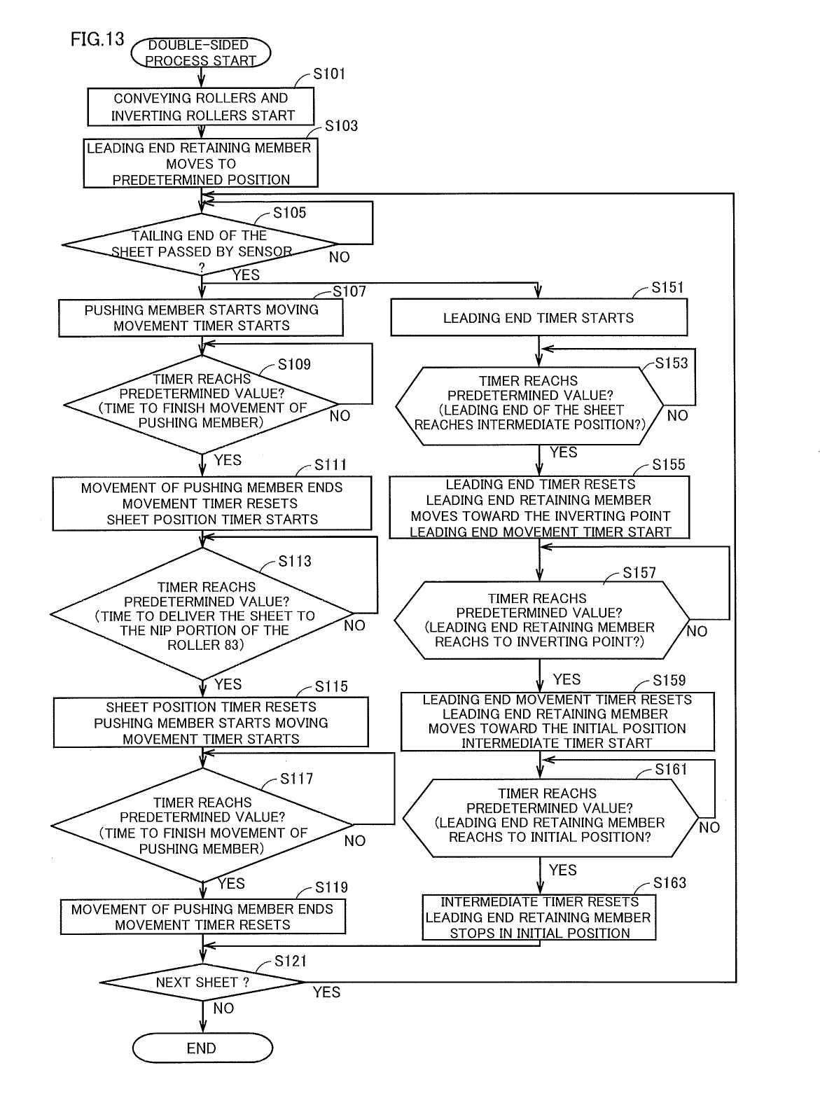

FIG. 13 is a flowchart illustrating the sheet conveying process, which is performed by CPU 101 of engine control board 30a, in sheet inverting unit 29 of the image forming apparatus in the fourth modification.

In FIG. 13, the pieces of processing in Steps S101, S103, and S107 to S121 are identical to those of the flowchart in FIG. 8, overlapping descriptions are omitted. In the flowchart in FIG. 13, in Step S105, CPU 101 determines whether the leading end portion of the sheet passes by sensor SE, and determines whether tailing end portion of the sheet passes by sensor SE. When the tailing end portion of the sheet passes by sensor SE, the pieces of processing from Step S107 are performed.

When the leading end portion of the sheet reaches sensor SE, the pieces of processing from Step S151 are performed.

The counting of a leading end timer is started in Step S151. In Step S153, CPU 101 determines whether the leading end timer reaches a predetermined value. The predetermined value means a value necessary for the leading end of the sheet to reach the initial position of leading end retaining member 87. When the affirmative determination is made in Step S153, the leading end timer is reset and leading end retaining member 87 is moved toward the inverting point in Step S155. The counting of a leading end movement timer is started.

In Step S157, CPU 101 determines whether the leading end movement timer reaches a predetermined value. The predetermined value means a value necessary for the leading end of the sheet and leading end retaining member 87 to reach the inverting point. When the affirmative determination is made in Step S157, the leading end movement timer is reset and leading end retaining member 87 is moved toward the initial position in Step S159. The counting of an intermediate timer is started.

In Step S161, CPU 101 determines whether the intermediate timer reaches a predetermined value. The predetermined value means a value necessary for the leading end of the sheet and leading end retaining member 87 to reach the initial position. When the affirmative determination is made in Step S161, the intermediate timer is reset and leading end retaining member 87 is stopped in the initial position in Step S163.

The moving speed of the leading end of the sheet is equal to the moving speed of leading end retaining member 87.

### [Fifth Modification]

In the case that the leading end retaining member 87 is not moved in association with the movement of the leading end of the sheet unlike the fourth embodiment but leading end retaining member 87 is fixed to the inverting point, the following flowchart is obtained.

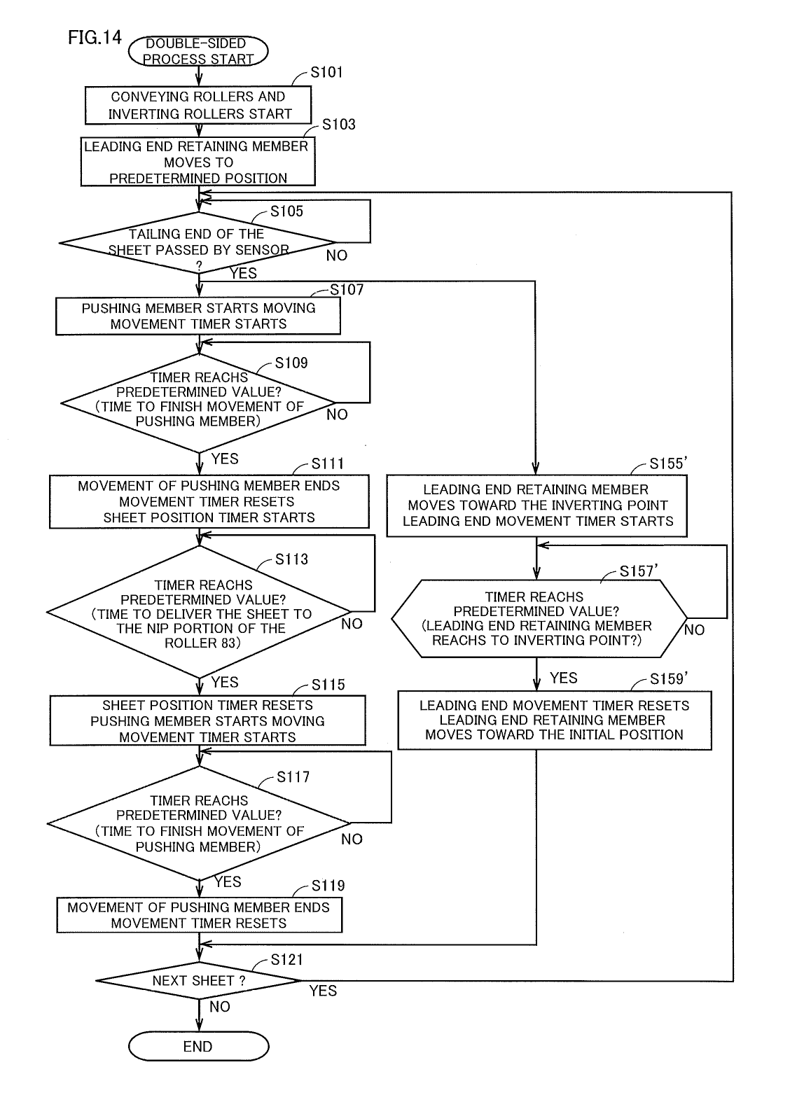

FIG. 14 is a flowchart illustrating the sheet conveying process, which is performed by CPU 101 of engine control board 30a, in sheet inverting unit 29 of the image forming apparatus when leading end retaining member 87 is fixed to the inverting point.

In FIG. 14, the pieces of processing in Steps S101, S103, and S107 to S121 are identical to those of the flowchart in FIG. 8, overlapping descriptions are omitted. In the flowchart in FIG. 14, in Step S105, CPU 101 determines whether the leading end portion of the sheet passes by sensor SE, and determines whether tailing end portion of the sheet passes by sensor SE. When the tailing end portion of the sheet passes by sensor SE, the pieces of processing from Step S107 are performed.

When the leading end portion of the sheet reaches sensor SE, the pieces of processing from Step S155′ are performed.

In Step S155′, leading end retaining member 87 is moved toward the inverting point that suits to the size and the direction of the next sheet. The counting of a leading end movement timer is started.

In Step S157′, CPU 101 determines whether the leading end movement timer reaches a predetermined value. The predetermined value means a value necessary for leading end retaining member 87 to reach the inverting point. When the affirmative determination is made in Step S157′, the leading end movement timer is reset and leading end retaining member 87 is moved toward the initial position (alternatively, leading end retaining member 87 is not moved to the initial position, but may be caused to wait) in Step S159′.

### [Sixth Modification]

In the configuration in FIG. 11, leading end retaining member 87 may be moved in association with the movement of the sheet.

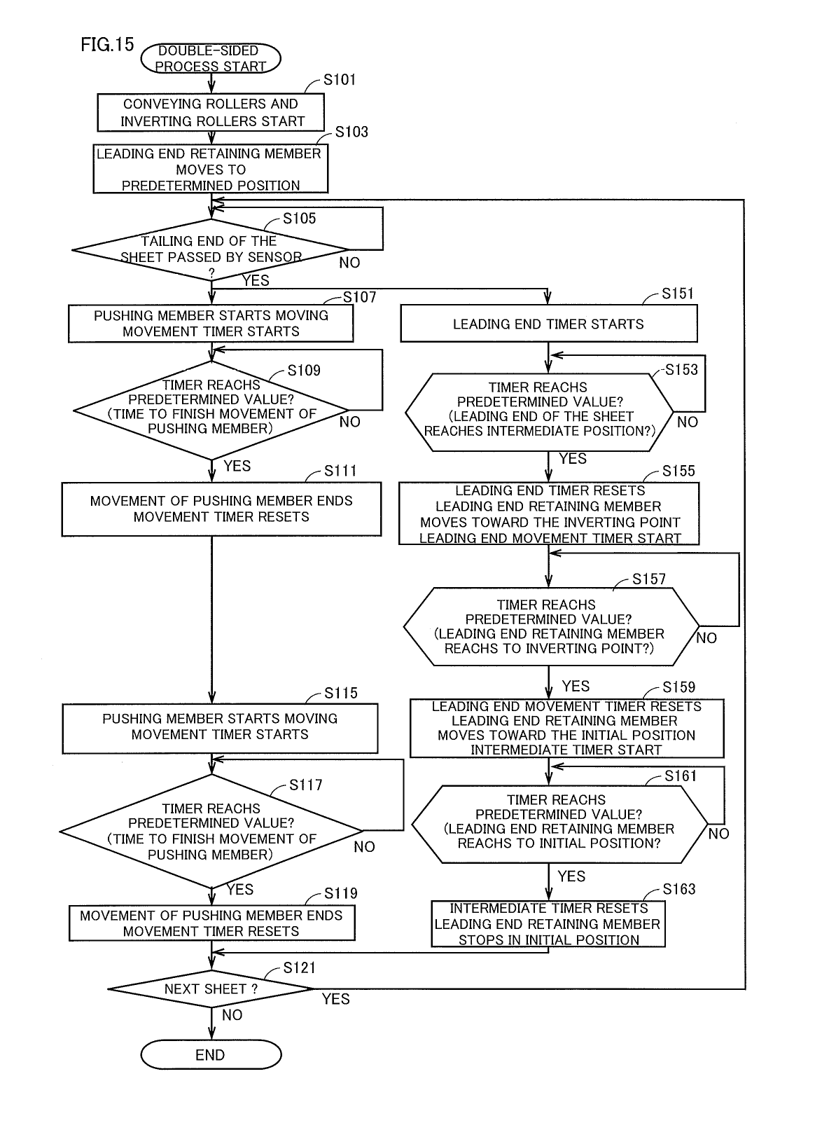

FIG. 15 is a flowchart illustrating the sheet conveying process, which is performed by CPU 101 of engine control board 30a, in sheet inverting unit 29 of the image forming apparatus when leading end retaining member 87 is moved in accordance with sheet movement in the configuration in FIG. 11.

In the example in FIG. 15, because the sheet can be sucked by fan 203 in FIG. 11, it is not necessary that pushing member 201 wait until the sheet is nipped between inverting and conveying rollers 83. Therefore, in the sixth modification, the pieces of processing relating to the sheet position timer are eliminated in the pieces of processing in Steps S111 to S115 compared with the flowchart in FIG. 13.

Specifically, in Step S111 in FIG. 15, the movement of pushing member 201 is ended and the movement timer is reset. Then, in Step S115, the movement of pushing member 201 toward the initial position is started and the counting of the movement timer is started.

Therefore, immediately after pushing member 201 moves to the left in FIG. 11 to suck the sheet to inverting and conveying belt 97, pushing member 201 moves to the right and waits. Through the pieces of processing in the sixth modification, the conveying interval of the sheets can further be shortened.

### ADVANTAGEOUS EFFECT OF EMBODIMENT

As described above, in the double-sided sheet conveying unit of the image forming apparatus, after the sheet conveyed from the fixing device is moved by the moving member, the sheet can be conveyed in the reverse feeding direction. In the reverse feeding direction, the sheet is conveyed while passing the subsequent sheet, so that the sheet interval can be shortened.

The sheet is moved between the routes by pushing the tailing end of the sheet using the member such as the roller, so that the sheet can be inverted without stopping the conveying action of the subsequent sheet. That is, the next sheet can be fed as long as only the tailing end of the preceding sheet is moved, so that the sheet interval can be shortened (the sheet interval can be shortened by eliminating a waiting time between the sheets during the inverting action).

Because the sheet is moved by pushing using the member, advantageously the sheet is stably moved (the sheet can securely be moved). The high-speed inversion can be performed while the conventional sheet route is used.

The sheet conveying action is performed while not stopped during the interval between the sheets, so that the motor start-up time and motor ending time can be shortened.

### [Other]

The image forming apparatus may be a monochrome/color copying machine, a printer, a facsimile machine, and a multi-function peripheral (MFP).

A program that executes the pieces of processing of the embodiment can be provided, or the program may be provided to the user while recorded in a recording medium such as a CD-ROM, a flexible disk, a hard disk, a ROM, a RAM, and a memory card. The program may be downloaded to the device through a communication line such as the Internet.

According to the embodiment, the sheet conveying device that can efficiently convey the sheet, the image forming apparatus, the sheet conveying device control method, and the sheet conveying device control program can be provided.

The embodiment is described only by way of example, and the invention is not limited to the embodiment. The scope of the invention is expressed not by the above description but claims, and it is understood that the invention includes the meaning equivalent to claims and all the changes within the scope of the invention.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A sheet conveying device comprising:
a first conveying unit for conveying a sheet;
a retaining unit for temporarily retaining a front portion in a conveying direction of the sheet conveyed by said first conveying unit;
a moving unit for moving a rear portion of said sheet toward a direction intersecting said conveying direction using a pushing member while said sheet is retained by said retaining unit, said pushing member being located on a downstream side of said first conveying unit; and
a second conveying unit for, after said moving unit moves said sheet, conveying said sheet while the rear portion of said sheet is set to a head.

2. The sheet conveying device according to claim 1, wherein
said retaining unit retains a leading end portion of said sheet in said sheet conveying direction, and
said moving unit turns said sheet while the leading end portion of said sheet retained by said retaining unit is used as a supporting point after a tailing end of said sheet passes through said first conveying unit.

3. The sheet conveying device according to claim 1, wherein said moving unit pushes said sheet by moving said pushing member located in an initial position, and said moving unit returns said pushing member to the initial position after a third conveying unit located on a downstream side of said second conveying unit can convey said sheet.

4. The sheet conveying device according to claim 1, wherein said moving unit pushes said sheet by moving said pushing member located in an initial position, and said moving unit returns said pushing member to the initial position at a time a sheet next to said sheet conveyed by said first conveying unit does not come into contact with said pushing member.

5. The sheet conveying device according to claim 4, wherein said first conveying unit conveys a sheet conveyed next to said sheet at a time a head of a sheet conveyed next to said sheet passes through said pushing member before said sheet passes through said second conveying unit.

6. The sheet conveying device according to claim 1, wherein said second conveying unit is one of a conveying roller and a conveying belt.

7. The sheet conveying device according to claim 1, wherein said second conveying unit includes a belt and two driving rollers that are disposed at both ends of the belt.

8. The sheet conveying device according to claim 1, wherein said second conveying unit sucks said sheet.

9. The sheet conveying device according to claim 8, wherein said second conveying unit includes a fan motor, and said sheet is sucked by said fan motor.

10. The sheet conveying device according to claim 1, wherein said pushing member is one of a rod-shaped member and a plate-like member.

11. The sheet conveying device according to claim 1, wherein
said pushing member is a first roller,
said second conveying unit includes a second roller that is provided opposite to said first roller,
said first roller moves toward said second roller, and said second conveying unit conveys said sheet by nipping said sheet between said first roller and said second roller.

12. The sheet conveying device according to claim 11, wherein
said second roller is a driving roller, and
said first roller is a driven roller of said second roller.

13. The sheet conveying device according to claim 11, wherein said moving unit pushes said sheet by moving said first roller located in an initial position, and said moving unit returns said first roller to the initial position after a third conveying unit located on a downstream side of said second conveying unit can convey said sheet.

14. The sheet conveying device according to claim 1, wherein said retaining unit waits in a predetermined position until said sheet is conveyed by said first conveying unit, and said retaining unit moves in the moving direction of said sheet in association with the movement of said sheet when a leading end of said sheet reaches a position of said retaining unit.

15. The sheet conveying device according to claim 1, wherein said retaining unit moves to a predetermined position in the moving direction of said sheet in association with the movement of said sheet when said second conveying unit starts conveyance of said sheet.

16. The sheet conveying device according to claim 1, wherein
said first conveying unit is a conveying roller, and
a distance L between a nip point of the conveying roller that is of said first conveying unit and a retaining position of said retaining unit satisfies a relationship of
L>L1+r
(where L1 is a length of said sheet in the conveying direction and r is a radius of the conveying roller that is of the first conveying unit).

17. The sheet conveying device according to claim 1, wherein
said pushing member is a roller,
a distance L2 in the sheet conveying direction between a center position of the roller that is of said pushing member and a tailing end of said sheet retained by said retaining unit satisfies a relationship of
L2>(t1+t2)×V1
(where t1 is a time necessary for said pushing member to press said sheet, t2 is a time necessary for said pushing member to return, and V1 is a sheet conveying speed of said first conveying unit).

18. The sheet conveying device according to claim 1, wherein
said pushing member is a roller,
said second conveying unit is a conveying roller,
said second conveying unit further includes a roller that is of a third conveying unit provided on a downstream side of said second conveying unit, and
a speed V2 at which said sheet is conveyed after said retaining unit retains said sheet satisfies a relationship of
V2≧V1×(L1+β−L3)/L1
(where V1 is a sheet conveying speed of said first conveying unit, L1 is a length of said sheet in the conveying direction, 13 is a distance from a nip portion between the roller that is of said pushing member and the conveying roller that is of said second conveying unit to a nip portion of the roller that is of said third conveying unit, and L3 is an interval between said sheet and a sheet subsequent to said sheet).

19. An image forming apparatus comprising:
the sheet conveying device according to claim 1; and
an image forming unit for forming an image in said sheet, wherein said sheet in which the image is formed by said image forming unit is conveyed by said sheet conveying device.

20. A sheet conveying device control method comprising the steps of:
a first conveying step of conveying a sheet using a first conveying unit;
a retaining step of retaining temporarily a front portion in a conveying direction of said sheet conveyed in said first conveying step;
a moving step of moving a rear portion of said sheet toward a direction intersecting said conveying direction using a pushing member while said sheet is retained in said retaining step, said pushing member being located on a downstream side of said first conveying unit; and
a second conveying step of conveying said sheet using a second conveying unit while the rear portion of said sheet is set to a head after said sheet is moved in said moving step.

21. The sheet conveying device control method according to claim 20, further comprising the steps of:
a retreating step of retreating to return said pushing member to an initial position by moving said pushing member in an opposite direction to the direction in which said pushing member is moved in said moving step; and
a third conveying step of conveying a sheet conveyed next to said sheet at a time a head of the sheet conveyed next to said sheet passes through said pushing member returned to the initial position in said retreating step before said sheet in which the conveyance is started in said second conveying step passes through said second conveying unit.

22. A non-transitory computer-readable recording medium encoded with a control program for sheet conveying device causing a computer to execute the steps of:
a first conveying step of conveying a sheet using a first conveying unit;
a retaining step of retaining temporarily a front portion in a conveying direction of said sheet conveyed in said first conveying step;
a moving step of moving a rear portion of said sheet toward a direction intersecting said conveying direction using a pushing member while said sheet is retained in said retaining step, said pushing member being located on a downstream side of said first conveying unit; and
a second conveying step of conveying said sheet using a second conveying unit while the rear portion of said sheet is set to a head after said sheet is moved in said moving step.
